(19) United States
(12) Patent Application Publication
(10) Pub. No.: US 2015/0268678 A1
(43) Pub. Date: Sep. 24, 2015

(54) SYSTEM AND METHOD FOR CURRENT MANAGEMENT IN A PORTABLE DEVICE

(71) Applicant: Qualcomm Incorporated, San Diego, CA (US)

(72) Inventors: Guolei Yu, Singapore (SG); Arvindh Rajasekaran, Bangalore (IN); Amy Derbyshire, Boulder, CO (US); Ching Chang Shen, La Jolla, CA (US)

(73) Assignee: QUALCOMM INCORPORATED, San Diego, CA (US)

(21) Appl. No.: 14/219,966

(22) Filed: Mar. 19, 2014

(51) Int. Cl. G05F 1/46

(52) U.S. Cl. CPC G05F 1/46

(57) ABSTRACT

The disclosed systems and methods for current management can be used with system-on-a-chip (SoC) integrated circuits in, for example, battery-powered portable devices. The current management provides detection of supply current levels from a power management integrated circuit (PMIC) to an SoC. The PMIC signals, for example, using interrupts, the SoC when the supply current levels exceed thresholds. The SoC can then alter its operations to avoid exceeding the current capability of the PMIC. The current management can avoid the SoC experiencing a functional failure due to loss of power during high current conditions. Additionally, development methods can be used to optimize a system for various conditions besides the traditional worst-case design commonly used.

### BACKGROUND

1. Field

The present invention relates to electronic systems and integrated circuits and, more particularly, to current management that may be used with system-on-a-chip (SoC) integrated circuits.

2. Background

As electronic devices have grown increasingly complex, their electrical current demands have also grown. The current demand of an electronic device can also vary greatly depending on what operations the device is performing. For example, the current draw of a mobile phone will vary greatly depending on whether the phone is performing a voice call, recording video, displaying streaming video, or idle. The current demand of an electronic device will also vary depending on process (variation in fabrication), voltage, and temperature conditions. The high current demand and large variation have made the design of power supplies complex. Combining the worst-case operating functions, the worst-case process conditions, the worst-case supply voltage, and the worst-case temperature can lead to a very large design margin for conditions that are more typical. Since a power supply can be expensive (e.g., the power transistors can occupy a large silicon area), the worst-case design can result in an overly expensive device.

FIG. 8 is functional block diagram of an electronic system including a power management integrated circuit (PMIC) 810 supplying a voltage to a system on a chip (SoC) 820. The SoC 820 includes a digital core module 822, for example, a programmable processor. The digital core module 822 receives a supply voltage from a voltage regular 812 in the PMIC 810. The current drawn from the supply voltage by the digital core module 822 varies with the operations being performed by the digital core module 822.

FIG. 9 is a waveform diagram illustrating operation of the electronic system of FIG. 8. In the waveforms illustrated in FIG. 9, the SoC current 920 gradually increases until at time 901 it has exceeded the capability of the PMIC 810. Until time 901 the SoC current 920 is below the maximum current 911 that the voltage regulator 812 is capable of supplying. While the SoC current 920 is below the maximum current capability of the PMIC, the output voltage supplied to the SoC (V_out 950) remains constant. When the SoC current 920 exceeds the maximum current 911, V_out 950 begins to fall. When V_out 950 falls, the SoC 820 will cease functioning correctly. This condition may be referred to as a brownout.

The PMIC 810 may include an overcurrent detection and may signal that the voltage regulator has detected an overcurrent condition by de-asserting a voltage regulator okay signal (VREG_ok 913). When the PMIC 810 detects the over-current condition, the voltage regulator 812 may shut off its output. This shut off can protect the PMIC from damage but also assures that the SoC ceases functioning.

Prior systems have attempted to avoid brownout conditions by increasing the current capability of the PMIC or by limiting the current drawn by the SoC. Limiting the current drawn by the SoC will generally decrease the performance of the SoC. Increasing the current capability of the PMIC will generally increase the cost of the PMIC. Some prior portable systems have measured battery charge or voltage to detect a current overload. Such systems can be expensive, complex, and difficult to design with different types of batteries needing different measurements.

### SUMMARY

This invention provides systems and methods for current management. The systems and methods may be used with system-on-a-chip (SoC) integrated circuits in, for example, battery-powered portable devices. The disclosed current management provides detection of supply current levels from a power management integrated circuit (PMIC) to an SoC. The PMIC signals, for example, using interrupts, the SoC when the supply current levels exceed thresholds. The SoC can then alter its operations to avoid exceeding the current capability of the PMIC.

The disclosed current management can provide various advantages. The disclosed current management can avoid the SoC experiencing a functional failure due to loss of power during high current conditions. The current management can also provide cost savings. For example, a system design may be optimized for more typical cases and thereby avoid the expense of a traditional design that addresses worst-case conditions. For example, the current management may prevent the integrated circuit from drawing its maximum power under the worst-case environmental conditions so that the PMIC does not have to be designed to supply maximum power under the worst-case environmental conditions. Additionally, the current management may also allow use of SoCs with a broader range of current draws that were manufactured with a broader range of process variations.

In one aspect, a system is provided that includes: a system-on-a-chip integrated circuit (IC); and a power management integrated circuit (PMIC) including a switch configured to provide a regulated voltage supply to the IC, a current sense module configured to sense current supplied by the switch, the current sense module coupled in parallel with the switch, and a current monitor module configured to compare the sensed current to one or more threshold values and to signal the IC whether the sensed current exceeds the one or more threshold values, wherein the IC is configured to modify its operation to change its current consumption from the regulated voltage supply based on the signaling from the PMIC indicating whether the current exceeds the threshold values.

In another aspect, a method is provided for current management in a system including a system-on-a-chip integrated circuit (IC) a power management integrated circuit (PMIC). The method includes: supplying, using a switch in the PMIC, a regulated voltage supply to the IC; sensing, using a current sense module coupled in parallel with the switch, current supplied by the PMIC to the IC; determining whether the sensed current exceeds one or more threshold values; signaling from the PMIC to the IC whether the sensed current exceeds the threshold values; and modifying operation of the IC to change its current consumption from the regulated voltage supply based on the signaling from the PMIC indicating that the sensed current exceeds the threshold values.

In another aspect, a system is provided that includes: a system-on-a-chip integrated circuit (IC); and a power management integrated circuit (PMIC) including a switch configured to provide a regulated voltage supply to the IC, a means for sensing current supplied by the switch coupled in parallel with the switch, and a means for monitoring the sensed current configured to determine whether the sensed current exceeds one or more threshold values and to signal the IC whether the sensed current exceeds the one or more threshold values, wherein the IC is configured to modify its operation to change its current consumption from the regulated voltage supply based on the signaling from the PMIC indicating whether the current exceeds the threshold values.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a functional block diagram of an electronic system with current management according to a presently disclosed embodiment;

FIG. 2 is a functional block diagram of a power management integrated circuit according to a presently disclosed embodiment;

FIG. 3 is a schematic diagram illustrating aspects of a power management integrated circuit according to a presently disclosed embodiment;

FIG. 4 is a waveform diagram illustrating operation of the electronic system of FIG. 1;

FIG. 5 is a graph illustrating characteristics of an electronic system with current management according to a presently disclosed embodiment;

FIG. 6 is a flowchart illustrating a process for development of an electronic system with current management according to a presently disclosed embodiment;

FIG. 7 is a flowchart illustrating operation of an electronic system with current management according to a presently disclosed embodiment:

FIG. 8 is a functional block diagram of an electronic system including a power management integrated circuit and a system-on-a-chip integrated circuit; and

FIG. 9 is a waveform diagram illustrating operation of the electronic system of FIG. 8.

### DETAILED DESCRIPTION

FIG. 1 is a functional block diagram of an electronic system with current management according to a presently disclosed embodiment. The system includes a power management integrated circuit (PMIC) 110 supplying a voltage to a system-on-a-chip (SoC) 120. The current management includes the SoC 120 throttling its current demand to avoid exceeding the capability of the PMIC 110. The current management can operate to assure that the current drawn by the SoC 120 does not exceed the capability of the PMIC 110 to supply current to the SoC 120.

The SoC 120 includes a digital core module 122, for example, a programmable processor that executes software instructions. The digital core module 122 receives a supply voltage from a voltage regulator 112 in the PMIC 110. The current drawn from the supply voltage by the digital core module 122 varies with the operations being performed by the digital core module 122. SoC 120 may also have many other modules, including modules that are analog. Similarly, the PMIC 110 may include voltage regulators that supply multiple voltages to the SoC 120 and to other components.

The voltage regulator 112 measures its output current and compares the current to one or more thresholds. The PMIC 110 signals the SoC 130 whether the current has exceeded one or more of the thresholds. The signaling may, for example, be in the form of interrupts. The signaling may also use polling. The signaling, in an embodiment, uses shared bus, for example, a system power management interface (SPMI). The PMIC 110 may operate as a request capable slave on the SPMI.

The SoC 120 includes a current management module 130. The current management module 130 receives the signals from the PMIC 110 indicating whether the current has exceeded one or more of the thresholds. The current management module 130, in response to signals from the PMIC 110 that one of the thresholds is exceeded, can cause the SoC to modify its operation to lower the current. For example, the current management module 130 may signal the digital core module 122 to switch to a lower frequency. The current management module 130, in response to signals from the PMIC 110 that one of the thresholds (this threshold may be a different threshold than the threshold that caused the SoC to lower its current) is not exceeded, can cause the SoC to modify its operation to increase the current (and restore performance). The current management module 130 may, in an embodiment, be implemented using a programmable processor and may, for example, be part of the digital core module 122.

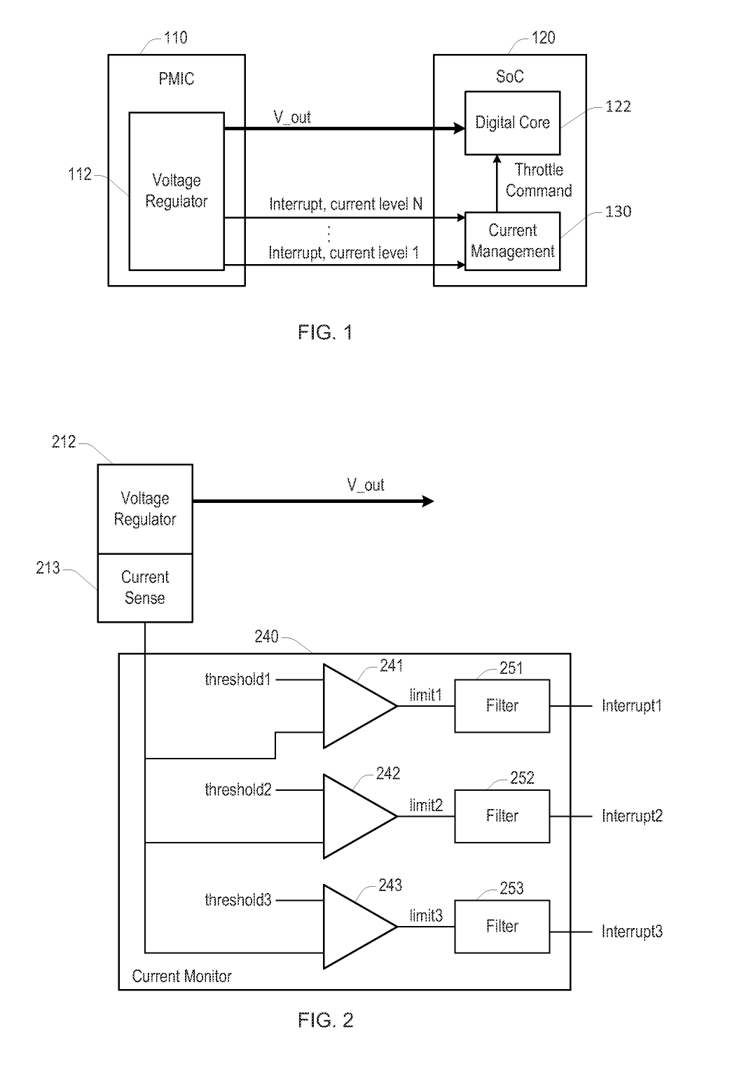

FIG. 2 is a functional block diagram of a PMIC according to a presently disclosed embodiment. The PMIC may be used to implement the PMIC 110 of the system of FIG. 1. The PMIC of FIG. 2 includes a voltage regulator 212 that supplies an output V_out. The voltage regulator 212 also supplies a current sense signal 213 that indicates the amount of current supplied to V_out. The PMIC also includes three comparators 241, 242, 243. The first comparator 241 compares the current sense to a first threshold (threshold1). When the current sense is greater than threshold1, a first limit signal (limit1) is active. A first filter module 251 filters limit1 to produce a first interrupt output (interrupt1) from the PMIC. The first filter module 251 may be, for example, a low pass filter to remove glitches, transients, or other spurious values on limit1. The first filter module 251 may use a counter for filtering, for example, when the voltage regulator 212 is a switching regulator.

A second comparator 242 and second filter module 252 operate in a similar manner to the first comparator 241 and the first filter module 251 but use a second threshold (threshold2) and produce a second interrupt output (interrupt2). A third comparator 243 and third filter module 253 operate in a similar manner to the first comparator 241 and the first filter module 251 but use a third threshold (threshold3) and produce a third interrupt output (interrupt3).

The values of the thresholds (threshold1, threshold2, threshold3) may be programmable, for example, by the digital core module 122 in the system of FIG. 1. The thresholds may be set, for example, so that the SoC 120 can modify its operations before the capabilities of the PMIC 110 are exceeded. The thresholds and the filtering may be used to provide hysteresis in the current management.

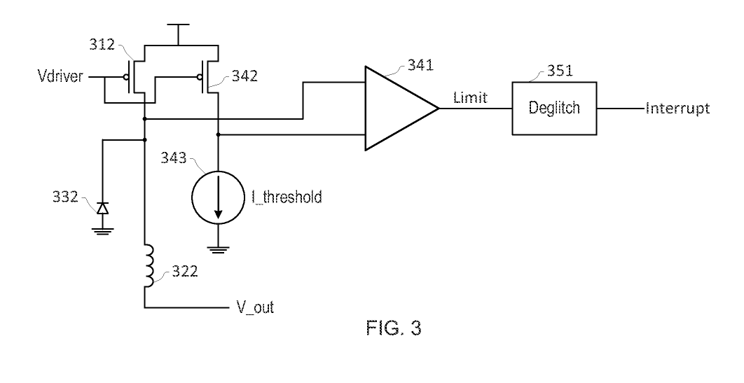

FIG. 3 is a schematic diagram illustrating aspects of a power management integrated circuit according to a presently disclosed embodiment. The figure illustrates an example technique for current sensing and threshold comparison and may be used with the power management integrated circuit of FIG. 2 and in the system of FIG. 1. The illustrated circuitry is for a buck regulator. Similar techniques can be used with other regulator types. An output transistor 312 drives the output voltage (V_out) through an inductor 322. The output transistor 312 has its source connected to an input supply voltage and its gate connected to a driver control signal (Vdriver). A diode 332 is connected between the switching output and the ground reference.

The current sensing uses a mirror transistor 342 that has its source and gate coupled in common with the source and gate of the output transistor 312. The mirror transistor 342 is a scaled version of the output transistor 312 so that the current through the mirror transistor 342 is a scaled copy of current from the output transistor 312. Current from the mirror transistor 342 is sunk by a current source 343. The current source 343 has a current magnitude of I_threshold. I_threshold is set to a value that is a scaled version of the actual output current threshold desired. For example, if the scale factor between the mirror transistor 342 and the output transistor 312 is 100 and the output current threshold desired is 500 mA, the current source 343 can have a current magnitude of 5 mA.

A comparator 341 compares the voltages on the drain of the output transistor 312 and the drain of the mirror transistor 342. When the voltage on the drain of the output transistor 312 is greater than the voltage on the drain of the mirror transistor 342, the output current is greater than the current threshold; and when the voltage on the drain of the output transistor 312 is less than the voltage on the drain of the mirror transistor 342, the output current is less than the current threshold. The comparator 341 may be clocked so the comparison is performed at the peak of the output current.

The output of the comparator 341 is supplied to a deglitch circuit 351. Due to the switching operation of a buck regulator, the current from the output transistor 312 ramps up to a high-value and then back to zero with each switching cycle of the regulator. Accordingly, the output of the comparator, when the magnitude of the current at its maximum in a cycle is large enough to exceed the current threshold, will turn on during the part of the cycle when the current is large and off-again when the current ramps down. The deglitch circuit 351 operates to filter the comparisons over multiple voltage regulator cycles. The deglitch circuit 351, for example, may detect when the comparison from the comparator 341 indicates that the current exceeded the threshold in a minimum number (e.g., three) of consecutive cycles. The deglitch circuit 351 asserts an interrupt output when the comparison indicates that the current exceeded the threshold for at least the minimum number of cycles.

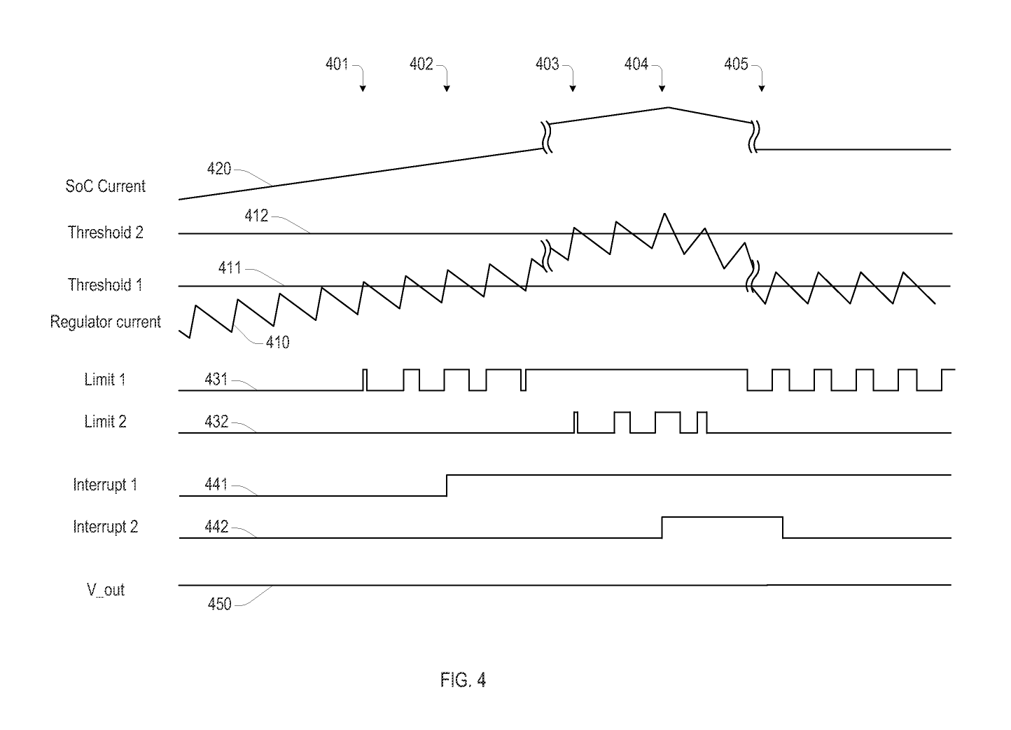

FIG. 4 is a waveform diagram illustrating operation of the system of FIG. 1. The waveforms of FIG. 4 illustrate the SoC 120 drawing increasing current, the current exceeding current limits, the PMIC 110 signaling interrupts to the SoC 120, and the SoC 120 decreasing its current draw in response to the interrupts.

As the SoC current 420 increases, the regulator current 410 also increases. The regulator current 410 ramps between high and low values with each switching cycle of the voltage regulator 112 with its time-average value equaling the SoC current 420. At time 401, the regulator current 410 ramps to a value that exceeds the first threshold 411 and the first limit signal 431 is active. The first threshold 411 may be set, for example, to 50% of the output capability of the PMIC 110. On subsequent cycles of the voltage regulator, the regulator current 410 also exceeds the first threshold 411. On the third cycle (for an implementation that filters the limit signal for three cycles) that the regulator current exceeds the first threshold 411, the first interrupt signal 441 goes active (time 402).

As the SoC current 420 continues to increase, at time 403, the regulator current 410 exceeds the second threshold 412 and the second limit signal 432 is active. On subsequent cycles of the voltage regulator, the regulator current 410 also exceeds the second threshold. The second threshold 412 may be set, for example, to 90% of the output capability of the PMIC 110. On the third cycle that the regular current exceeds the second threshold 412, the second interrupt signal 442 goes active (time 404).

In response to the second interrupt, the SoC 120 modifies its operations to decrease the SoC current 420. For example, the digital core 122 may begin performing some of its operations more slowly. Thereafter, at time 405, the currents have decreased so that the regulator current 410 no longer exceeds the second threshold 412 and the second interrupt 442 is de-asserted.

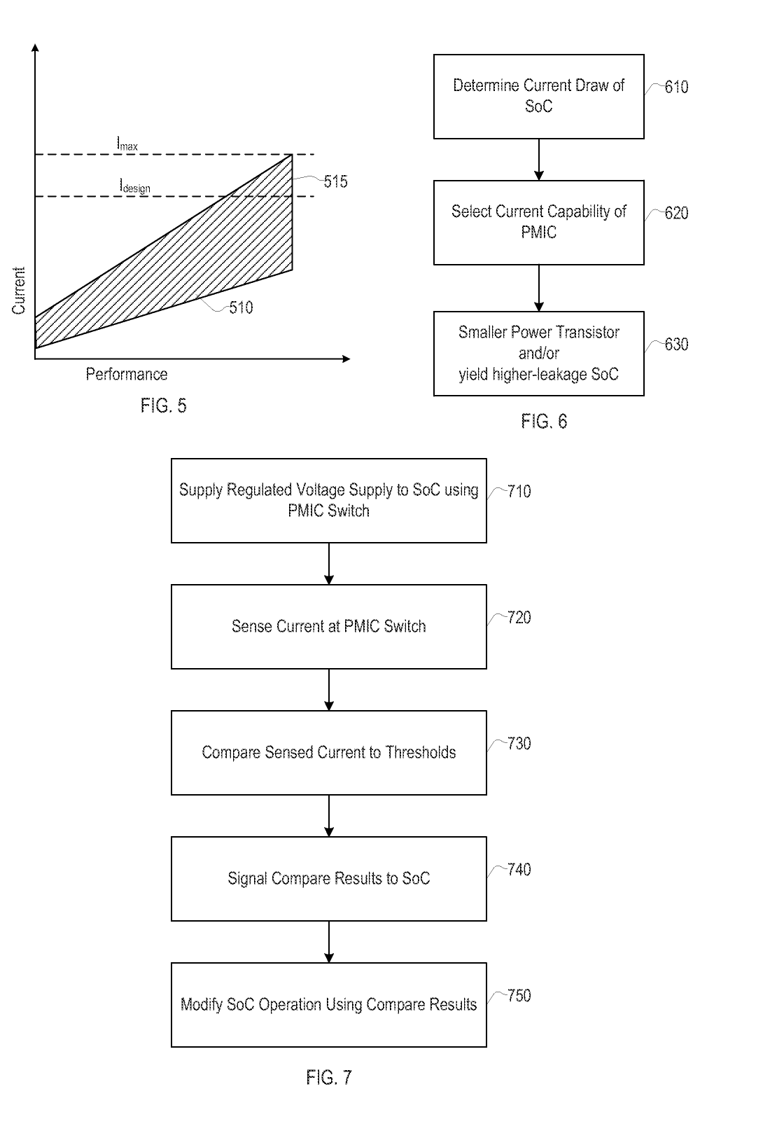

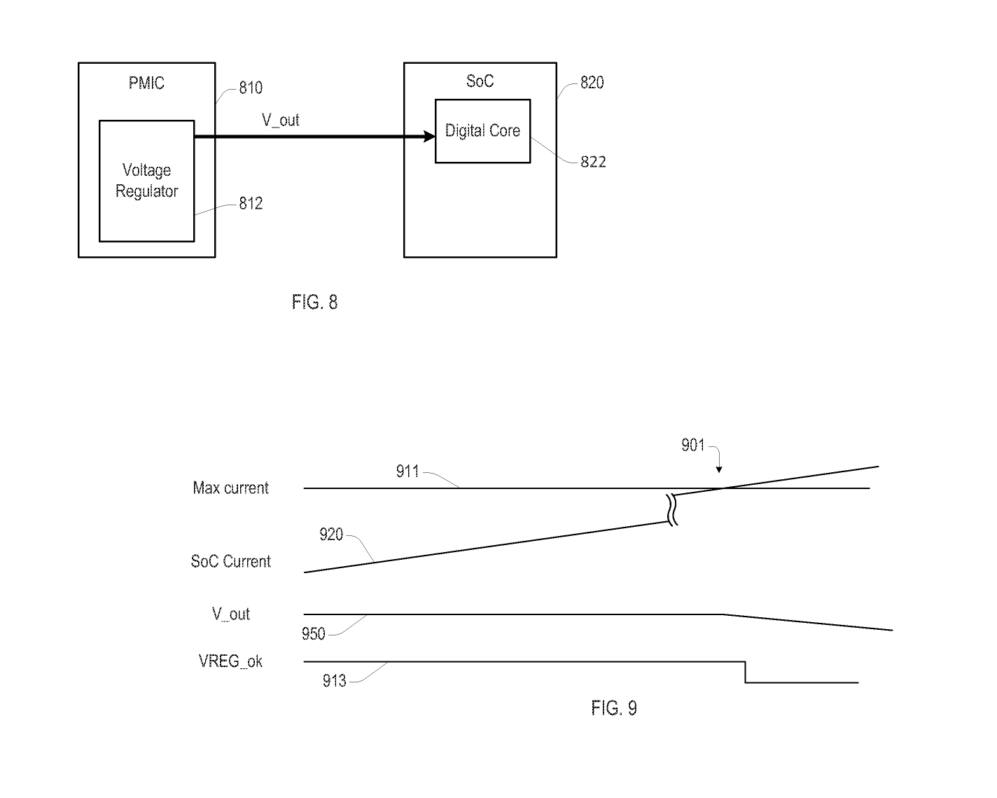

FIG. 5 is a graph illustrating characteristics of an electronic system with current management according to a presently disclosed embodiment. The graph illustrates relationships between current drawn by an SoC and performance of the SoC. The current falls in the range 510. Generally the current increases as performance increases. The variation in current at a particular performance level may be based on, for example, variation in fabrication processing of the SoC. The variation in current at a particular performance level may also depend on the operating temperature of the SoC.

Traditional design techniques would design a PMIC to be able to supply the maximum current (Iₘₐₓ) that the SOC would draw at its maximum performance taking into account the worst-case variation in current. Alternatively, a design current level (I_{design}) that is lower than the maximum, worst-case current level may be selected for the PMIC. When the design current level is less than the maximum possible current, the system should operate to prevent operation at current levels above the design current. That is, the system should exclude operation in the range 515 illustrated in FIG. 5. This may be effected using the current management described herein.

FIG. 6 is a flowchart illustrating a process for development of an electronic system with current management according to a presently disclosed embodiment. The process of FIG. 6 may be used to develop many types of systems. To provide a specific example, the process will be described with reference to the system of FIG. 1.

In step 610, the current draw of the SoC 120 is determined. The current draw of the SoC 120 can include a range of currents for different operating conditions (e.g., functions being performed), process conditions, temperature, and voltages. For example, a range 510 as illustrated in FIG. 5 may be determined.

In step 620, the current capability of the PMIC 110 is selected. The selected current capability can be less than the maximum of the current draw determined in step 610. This can allow various tradeoffs to be chosen between performance and cost. The current capability may be selected, for example, so that the SOC can operate at its maximum performance at typical temperatures but not at its maximum temperature. The selected current may also be for PMIC conditions that are not the worst-case.

In step 630, a design having a smaller power transistor in the PMIC 120 is created. The use of a small power transistor can save cost. Alternatively or additionally, other power supply components can be changed, for example, a smaller or less-expensive inductor may be used. Alternatively or additionally, an SoC 120 having a higher leakage current may be used in the system. The use of an SoC having a higher current (e.g., leakage current) may provide a greater manufacturing yield for the SoC 120. That is, SoCs that would otherwise have been discarded can still be used.

FIG. 7 is a flowchart illustrating operation of an electronic system with current management according to a presently disclosed embodiment. The process of FIG. 7 may be performed by various types of systems. To provide a specific example, the process will be described with reference to the system of FIG. 1.

In step 710, a regulated voltage supply is supplied from the PMIC 110 to the SoC 120. The level of the voltage may, in an embodiment, be dynamically controlled. In step 720, the current supplied by the PMIC 110 on the regulated voltage supply is sensed. The current may be sensed, for example, using the circuitry illustrated in FIG. 3.

In step 730, the sensed current is compared to threshold levels. In step 740, the results of the comparison are signaled from the PMIC 110 to the SoC 120. In an embodiment, the PMIC 110 signals the SoC 120 when the threshold levels are exceeded.

In step 750, the SoC 120 may modify its operation to change the current draw based on the results of the comparison of the current level to the thresholds. For example, when a first current threshold is exceeded, the SoC 120 may slow the rate at which it performs one of its tasks. For another example, when a larger current threshold is exceeded, the SoC 120 may stop performing one of its tasks.

The process of FIG. 7 may be modified, for example, by adding, omitting, reordering, or altering steps. Additionally, steps may be performed concurrently.

Although embodiments of the invention are described above for particular embodiments, many variations of the invention are possible including those with different numbers of voltage supplies, different numbers of thresholds, and different numbers of SoCs. In an embodiment with multiple voltage regulators, only some of the regulars may include current sensing and signaling of current levels. For example, a voltage regulator that supplies current to a circuit block that cannot be throttled (e.g., an analog or radio-frequency circuit) may omit current sensing. Additionally, features of the various embodiments may be combined in combinations that differ from those described above. For example, functions of the PMIC may be integrated with the SoC.

Although some embodiments have been described for mobile phones, the current management systems and methods can be used with other devices including devices that are not battery-powered. Similarly, some embodiments have been described for buck regulators, but other regulator types (e.g., low dropout (LDO) converters) may also be used.

Those of skill will appreciate that the various illustrative blocks and modules described in connection with the embodiments disclosed herein can be implemented in various forms. Some blocks and modules have been described above generally in terms of their functionality. How such functionality is implemented depends upon the design constraints imposed on an overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A system, comprising:
a system-on-a-chip integrated circuit (IC); and
a power management integrated circuit (PMIC) including
a switch configured to provide a regulated voltage supply to the IC,
a current sense module configured to sense current supplied by the switch, the current sense module coupled in parallel with the switch, and
a current monitor module configured to compare the sensed current to one or more threshold values and to signal the IC whether the sensed current exceeds the one or more threshold values,
wherein the IC is configured to modify its operation to change its current consumption from the regulated voltage supply based on the signaling from the PMIC indicating whether the current exceeds the threshold values.

2. The system of claim 1, wherein the current monitor module includes:
one or more comparators configured to produce one or more limit signals, each of the comparators configured to compare the sensed current to one of the threshold values and produce one of the limit signals based on the respective comparison; and
one or more filter modules configured to produce output signals based on the limit signals.

3. The system of claim 2, wherein the switch is an output transistor of a switching regulator and the one or more filter modules produce the output signals based on values of the limit signals on consecutive cycles of the switching regulator.

4. The system of claim 3, wherein the current sense module includes a mirror transistor that mirrors the output transistor, the mirror transistor coupled in series with a current source.

5. The system of claim 1, wherein the one or more threshold values include two values that are programmable by the IC.

6. The system of claim 5, wherein the IC is configured to modify its operation to change its current consumption using a hysteresis based on the two values that are programmable by the IC.

7. The system of claim 1, wherein the current monitor module signals the IC whether the sensed current exceeds the threshold values using a shared bus.

8. The system of claim 1, wherein a capability of the PMIC to supply current to the IC is less than a maximum current draw of the IC for at least one operating condition of the IC.

9. A method for current management in a system including a system-on-a-chip integrated circuit (IC) and a power management integrated circuit (PMIC), the method comprising:
supplying, using a switch in the PMIC, a regulated voltage supply to the IC;
sensing, using a current sense module coupled in parallel with the switch, current supplied by the PMIC to the IC;
determining whether the sensed current exceeds one or more threshold values;
signaling from the PMIC to the IC whether the sensed current exceeds the threshold values; and
modifying operation of the IC to change its current consumption from the regulated voltage supply based on the signaling from the PMIC indicating that the sensed current exceeds the threshold values.

10. The method of claim 9, wherein the switch is an output transistor of a switching regulator, and wherein determining whether the sensed current exceeds one or more threshold values includes comparing the sensed current to the one or more threshold values to produce one or more limit signals and filtering the limit signals based on values of the limit signals on consecutive cycles of the switching regulator.

11. The method of claim 9, wherein the one or more threshold values include two values that are programmable by the IC, and wherein modifying operation of the IC to change its current consumption includes using a hysteresis based on the two values that are programmable by the IC.

12. The method of claim 9, wherein a capability of the PMIC to supply current to the IC is less than a maximum current draw of the IC for at least one operating condition of the IC.

13. A system, comprising:
a system-on-a-chip integrated circuit (IC); and
a power management integrated circuit (PMIC) including
a switch configured to provide a regulated voltage supply to the IC,
a means for sensing current supplied by the switch coupled in parallel with the switch, and
a means for monitoring the sensed current configured to determine whether the sensed current exceeds one or more threshold values and to signal the IC whether the sensed current exceeds the one or more threshold values,
wherein the IC is configured to modify its operation to change its current consumption from the regulated voltage supply based on the signaling from the PMIC indicating whether the current exceeds the threshold values.

14. The system of claim 13, wherein the means for monitoring the sensed current includes:
one or more comparators configured to produce one or more limit signals, each of the comparators configured to compare the sensed current to one of the threshold values and produce one of the limit signals based on the respective comparison; and
one or more filter modules configured to produce output signals based on the limit signals.

15. The system of claim 14, wherein the switch is an output transistor of a switching regulator and the one or more filter modules produces the output signal based on values of the limit signals on consecutive cycles of the switching regulator.

16. The system of claim 15, wherein the means for sensing current includes a mirror transistor that mirrors the output transistor, the mirror transistor coupled in series with a current source.

17. The system of claim 13, wherein the one or more threshold values include two values that are programmable by the IC.

18. The system of claim 17, wherein the IC is configured to modify its operation to change its current consumption using a hysteresis based on the two values that are programmable by the IC.

19. The system of claim 13, wherein the means for monitoring the sensed current signals the IC whether the sensed current exceeds the threshold values using a shared bus.

20. The system of claim 13, wherein a capability of the PMIC to supply current to the IC is less than a maximum current draw of the IC for at least one operating condition of the IC.
